(19) United States
(12) Patent Application Publication
(10) Pub. No.: US 2007/0149781 A1
(43) Pub. Date: Jun. 28, 2007

(54) Process for preparing bisphospholane ligands

(75) Inventors: Thomas Riermeier, Nidderau-Ostheim (DE); Axel Monsees, Frankfurt (DE); Juan Jose Almena Perea, Hanau (DE); Renat Kadyrov, Frankfurt (DE); Battsengel Gotov, Koln (DE); Werner Zeiss, Eurasburg (DE); Iris Nagl, Munchen (DE); Armin Borner, Rostock (DE); Jens Holz, Kessin (DE); Karlheinz Drauz, Freigericht (DE); Wilfried Meichelbock, Krailling (DE)

Correspondence Address: LAW OFFICE OF MICHAEL A. SANZO, LLC, 15400 CALHOUN DR., SUITE 125, ROCKVILLE, MD, 20855, US

(73) Assignee: Degussa AG, Dusseldorf (DE)

(21) Appl. No.: 10/579,807

(22) PCT Filed: Oct. 29, 2004
(86) PCT No.: PCT/EP04/12279

§ 371 Date: May 16, 2006

(30) Foreign Application Priority Data
Nov. 18, 2003 (DE) 10353831.3

(51) Int. Cl. C07F 9/02; C07F 9/6509; C07F 9/6506

(52) U.S. Cl. 544/337; 548/111; 549/216; 552/294; 568/9

(57) ABSTRACT

The present invention is directed at a process for preparing enantiomerically enriched compounds of the general formula (I). 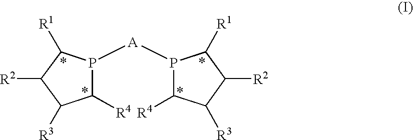 Compounds of the type shown are employed in catalyst systems.

The present invention is directed at a process for the preparation of bidentate ligands based on bisphospholanes. In particular, the invention relates to the preparation of enantiomerically enriched compounds of the general formula (I):

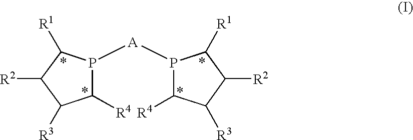

Enantiomerically enriched ligands are used in asymmetric synthesis or asymmetric catalysis. The important thing here is that the electronic and stereochemical properties of the ligand are optimally matched to the respective catalysis problem. An important aspect of the success of this class of compounds is believed to be the creation of an asymmetric environment around the metal centre due to these ligand systems. To utilize such an environment for effective transfer of the chirality, it is advantageous to control the flexibility of the ligand system as inherent limitation of the asymmetric induction.

Within the class of phosphorus-containing ligands, cyclic phosphines, in particular phospholanes, have attained particular importance. Bidentate, chiral phospholanes are, for example, the DuPhos and BPE ligands used in asymmetric catalysis. In the ideal case, these provide a chiral ligand framework which can be modified in a variety of ways and can be varied within a broad range in terms of its steric and electronic properties.

DE10309356 describes concrete ligand systems and a route for preparing them. The synthetic route presented there starts out from phenylphosphine which is converted into a dimetal phenolphosphine by deprotonation with a strong base before the reaction to form the phospholane is carried out.

EP528865 describes the preparation of phospholanes starting from dilithiophenylphosphine and a bifunctional alkylation reagent. The preparation of the dilithiophenylphosphine is not mentioned.

EP1028967, JOC 2003, 68, 1701-1707 and Org. Lett. 2003, 5, 1273-75, present preparations of enantiomerically enriched phospholanes. Here too, the conversion into the phospholane is brought about using phenolphosphine or a lithiated bistrimethylsilylphosphide.

It was an object of the present invention to provide a further process for preparing the abovementioned phospholanes and enantiomerically enriched ligands. In particular, the process should be economical on/an industrial scale from both economic and ecological points of view. Very particular value should be attached to a process which starts out from materials which are readily available commercially and uses reagents which can be handled relatively unproblematically.

Such a process is proposed in the claims. Claim 1 describes a process for preparing the desired ligand systems. The dependent subordinate Claims 2 to 13 are directed at preferred embodiments of the process of the invention.

Carrying out a process for preparing enantiomerically enriched compounds of the general formula (I), 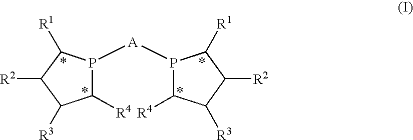
where
* indicates a stereogenic centre,
R¹ and R⁴ are each, independently of one another (C₁-C₈)-alkyl, HO—(C₁-C₈)-alkyl, (C₁-C₈)-alkoxy, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₃-C₈)-alkyl,
R² and R³ are each, independently of one another, H, (C₁-C₈)-alkyl, HO—(C₁-C₈)-alkyl, (C₁-C₈)-alkoxy, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₃-C₈)-alkyl-(C₃-C₈)-cycloalkyl, (C₃-C₈)-cycloalkyl-(C₁-C₈)-alkyl,
A is a C₂ bridge in which two carbon atoms have sp² hybridization, starting from compounds of the general formula (II), 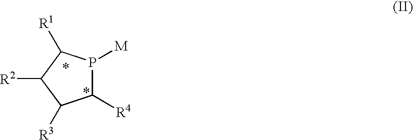
where
R¹ to R⁴ can be as defined above,
M is an alkali metal or a trimethylsilyl group, and reacting these with compounds of the general formula (III),
X-A-X (III)
where
A is as defined above and
the radicals X are each, independently of one another, a nucleofugic leaving group, and preparing the compounds of the general formula (II) by reacting compounds of the general formula (IV), 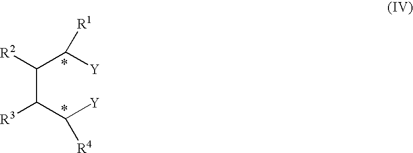
where
R¹ to R⁴ are as defined above and
the radicals Y are each, independently of one another, a nucleofugic leaving group,
with compounds of the general formula (V),
M₂P-Aryl (V)
where
M is an alkali metal and Aryl is a (C₆-C₁₈)-aryl or ((C₁-C₈)-alkyl)₁₋₃-(C₆-C₁₈)-aryl radical, and subsequently with an alkali metal and additionally, if appropriate, with trimethylsilyl chloride,
with the compounds of the formula (V) being obtained by reaction of compounds of the general formula (VI),
Hal₂P-Aryl (VI)
where
Aryl is as defined above,
with an alkali metal, enables the ligand systems in question to be obtained simply and particularly advantageously according to the invention. It was particularly surprising that the procedure described achieves a relatively good increase in yield, which was not to have been expected from the prior art.

The process described above is preferably applied to compounds in which A is a radical from the group consisting of 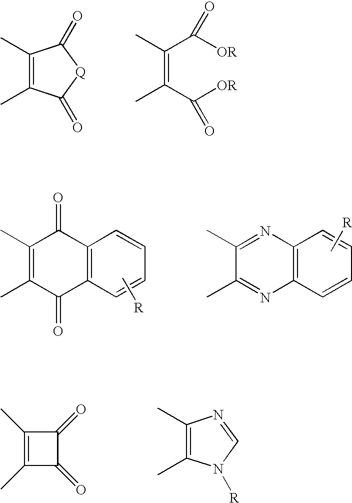
where
R is H, (C₁-C₈)-alkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl, and Q is O, NH, NR. Q in these formulae is particularly preferably oxygen or NR, with R being able to be (C₁-C₈)-alkyl, (C₆-C₁₈)-aryl, benzyl. Especially preferred radicals R are methyl, ethyl, propyl, isopropyl, tert-butyl, phenyl, naphthyl, fluorenyl, benzyl.

Preference is likewise given to using compounds of the formula (IV) in which R² and R³ are each H and R¹ and R⁴ are each, independently of one another, (C₁-C₈)-alkyl, HO—(C₁-C₈)-alkyl, (C₂-C₈)-alkoxyalkyl.

Preference is also given to using compounds of the general formula (III) or (IV) in which X or Y is selected from the group consisting of halogen, Otos (p-toluenesulfonate), OMes (methylsulfonate), triflate (trifluoroacetate), p-nitrobenzenesulfonate (nosylate, ONs) in the process of the invention.

Particular preference is likewise given to using compounds of the general formula (VII) or (VIII), for compounds of general formula (IV) 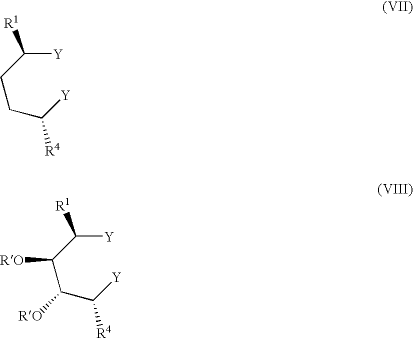
where
the radicals Y are selected independently from the group consisting of halogen, OTos, OMes, triflate, nosylate,
R¹ and R⁴ are each, independently of one another, (C₁-C₈)-alkyl, HO—(C₁-C₈)-alkyl, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl,
the radicals R′ are each, independently of one another, H, (C₁-C₈)-alkyl, HO—(C₁-C₈)-alkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl.

Very particular preference is given to compounds of the formula (VII) or (VIII) in which R′ is H, methyl, ethyl, propyl, isopropyl, tert-butyl, phenyl, and R¹ and R⁴ are each methyl, ethyl, propyl, isopropyl, tert-butyl, phenyl.

In principle, all elements of main group 1 of the Periodic Table can be employed as alkali metals. Preference is here given to lithium, sodium and potassium, with lithium being especially preferred as the metal to be used.

The solvents to be used for the individual steps of the process can be selected by a person skilled in the art on the basis of his general technical knowledge. The solvents should be solvents which do not if at all possible, promote any secondary reactions and are themselves inert under the reaction conditions. The reaction of compounds of the general formula (VI) with alkali metals is preferably carried out in an aprotic polar solvent. Very particular preference is here given to ethers such as THF, diethyl ether, dioxane, DME or DEE.

The temperature window within which the reaction according to the invention is carried out can likewise be selected freely by a person skilled in the art. Here, a person skilled in the art will be guided by efficiency factors such as space-time yield, energy costs and by-products spectra and set a temperature which helps to ensure an optimal reaction. The reaction of the compound (IV) with the compound (V) is preferably carried out at a temperature of from −50° C. to +100° C., more preferably from −30° C. to +80° C. and particularly preferably from −25° C. to +40° C. The reaction of compounds of the general formula (VI) with alkali metals can, on the other hand, be carried out at temperatures of from −25° C. to +40° C., preferably from −15° C. to +30° C. and particularly preferably from −10° C. to +10° C.

In a further, preferred embodiment of the present process, the reactions of (VI) with alkali metals to form (V) and subsequently with (IV) and also the further reaction of the products obtained to form (III) and finally with (II) to form (I) can be carried out in a single vessel. Thus, the entire reaction can be carried out in a simple fashion as a one-pot synthesis.

The present process thus offers a further very decisive advantage over the synthetic routes disclosed in the prior art. Furthermore, the choice of starting substances means that no strong, difficult-to-handle bases, e.g. alkyllithium compounds, have to be used in the synthesis. As a result, the present route can be carried out on an industrial scale without costly safety equipment and precautions, which in the final analysis helps make the products cheaper and thus economically more attractive.

The present invention is generally carried out as follows:

In step 1, the compounds of the formula (IV) are prepared as shown by way of example in the following scheme.

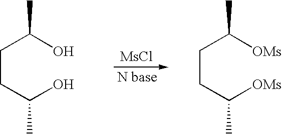

The compounds of the general formula (V) are subsequently prepared and are then reacted with the compounds of the formula (IV).

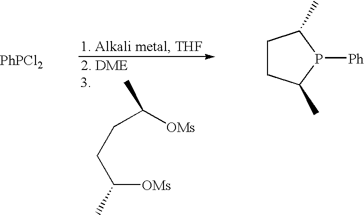

After this, the further synthesis after phenyl/lithium/trimethylsilyl exchange can be completed by reaction of the compounds of the formula (III) with those of the formula (II).

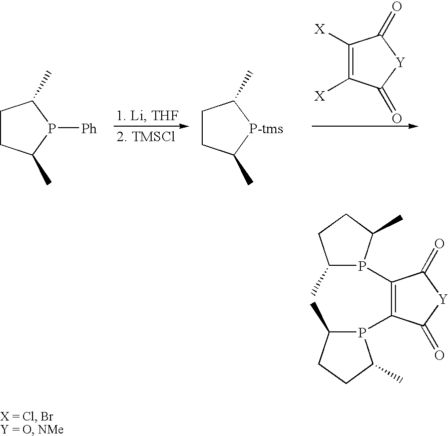

The overall yield can reach values of >60%, preferably >65% and very particularly preferably >70%, starting from compounds of the formula (VI).

For the purposes of the present invention, (C₁-C₈)-alkyl is methyl, ethyl, n-propyl, isopropyl, n-butyl, isobutyl, sec-butyl, tert-butyl, pentyl, hexyl, heptyl or octyl, including all bonding isomers.

The term (C₁-C₈)-alkoxy refers to (C₁-C₈)-alkyl radicals which are bound via an oxygen atom to the respective molecule.

The term (C₁-C₈)-alkoxyalkyl refers to (C₁-C₈)-alkyl radicals which have an oxygen atom in their chain.

The term (C₃-C₈)-cycloalkyl encompasses cyclopropyl, cyclobutyl, cyclopentyl, cyclohexyl and cycloheptyl radicals, etc.

For the purposes of the present invention, a (C₆-C₁₈)-aryl radical is an aromatic radical having from 6 to 18 carbon atoms. In particular, such radicals include phenyl, naphthyl, anthryl, phenanthryl, biphenyl radicals.

A (C₇-C₁₉)-aralkyl radical is a (C₆-C₁₈)-aryl radical bound via a (C₁-C₈)-alkyl radical to the molecule.

Nucleofugic leaving groups are, in particular: halogen, Otosyl (OTos), Omesyl (OMes), triflate, nosylate.

Possible halogens (Hal) are chlorine, bromine and iodine.

For the purposes of the invention, the term enantiomerically enriched means that the proportion of one enantiomer in the mixture with its opposite enantiomer is in a range from >50% and <100%.

The structures shown encompass all possible diastereomers and the enantiomers (R, S form) coming under the respective diastereomer.

The references cited are hereby incorporated by reference into the disclosure of the present invention.

### EXAMPLES

The following examples serve to illustrate the invention. They do not in any way constitute a restriction.

### Example 1

### (2S,5S)-2,5-Hexanediol bismesylate

Variant 1:

60 g of (2S,5S)-2,5-hexanediol are dissolved in 400 ml of dichloromethane and 177 ml of triethylamine and the solution is cooled to 0° C. The methanesulfonyl chloride is added dropwise as a solution in 50 ml of dichloromethane, with the temperature being kept below 30° C. The reaction solution is stirred at room temperature for 60 minutes and subsequently hydrolyzed with 200 ml of water. The phases are separated and the aqueous phase is extracted once with dichloromethane. The organic phase is washed with saturated sodium chloride solution, dried and the solvent is removed under reduced pressure.

Yield: 138.5 g; 99%

Variant 2:

120 g of (2S,5S)-2,5-hexanediol are suspended in 450 ml of toluene and 353.5 ml of triethylamine and the mixture is cooled to 5° C. A solution of 255.9 ml of methanesulfonyl chloride in 50 ml of toluene is added dropwise to this suspension, with the temperature being kept below 30° C. The reaction solution is stirred at room temperature for 1 hour and subsequently hydrolyzed with 250 ml of water. The phases are separated and the aqueous phase is extracted once with toluene. The organic phase is washed with saturated sodium chloride solution and subsequently dried over magnesium sulfate. The solvent is removed under reduced pressure.

Yield: 256.7 g; 92%

### Example 2

### (2R,5R)-2,5-Dimethyl-1-phenylphospholane

Variant 1:

44.4 g of lithium are suspended in 400 ml of THF and the mixture is cooled to 0° C. 143.2 g of dichlorophenylphosphine (dissolved in 200 ml of THF) are slowly added dropwise to this reaction mixture, with the temperature being kept below 30° C. The orange suspension is stirred for 1 hour and the THF is subsequently removed under reduced pressure. The residue is taken up in 600 ml of dimethoxyethane and refluxed for 5 hours. After cooling to room temperature, the suspension is transferred to a further reaction vessel, with the residual lithium remaining in the first vessel. The suspension is cooled to −20° C. and 195 g of (2S,5S)-2,5-hexanediol bismesylate (dissolved in 200 ml of toluene) are subsequently added, with the temperature being kept below 5° C. The reaction mixture is stirred at room temperature for a further 8 hours and the solvent is subsequently removed under reduced pressure. The residue is taken up in 500 ml of heptane, the mixture is filtered and the solid is washed twice with 300 ml each time of heptane. The heptane is removed under reduced pressure and the crude product is subsequently distilled (87-89° C./1 mbar)

Yield: 97.1 g; 71%

1H-NMR (C6D6): δ=0.70 (dd 3H), 1.11-1.30 (m, 2H), 1.20 (dd, 3H), 1.65 (m 1H), 2.00-2.45 (m, 3H), 7.50-7.30 (5H) ppm.

31P-NMR (C6D6): δ=11.1 ppm.

Variant 2: (Comparison)

375 ml of methyllithium (1.6 M in ether) are added at −20° C. to a solution of 32 g of phenylphosphine in 300 ml of THF. After the addition, the solution is warmed to room temperature and stirred for 1 hour. 72.5 g of (2S,5S)-2,5-hexanediol bismesylate are dissolved in 75 ml of THF and added to the reaction solution at −20° C. The reaction mixture is warmed to room temperature and stirred for 16 hours. The solvent is subsequently removed under reduced pressure and the residue is taken up in 400 ml of heptane. The reaction mixture is filtered and the residue is washed with 200 ml of heptane. The solvent is removed under reduced pressure and the product is distilled under reduced pressure (72-75° C./0.5 mbar).

Yield: 26.5 g; 52%

Variant 3: (Comparison)

113 ml of butyllithium (1.6 M in hexane) are added at −30° C. to a solution of 99 g of phenylphosphine (10% strength in hexane) in 300 ml of THF. After the addition, the solution is warmed to room temperature and stirred for 1 hour. 22.5 g of (2S,5S)-2,5-hexanediol bismesylate are dissolved in 50 ml of THF and added to the reaction solution at −30° C. The reaction mixture is warmed to room temperature and stirred for 16 hours. The solvent is subsequently removed under reduced pressure and the residue is taken up in 100 ml of heptane. The reaction mixture is filtered and the residue is washed with 100 ml of heptane. The solvent is removed under reduced pressure and the product is distilled under reduced pressure (69-75° C./0.5 mbar).

Yield: 11.65 g; 67%

### Example 3

### (2R,5R)-2,5-Dimethyl-1-trimethylsilylphospholane

1.67 g of lithium are suspended in 60 ml of THF. 7.75 g of (2S,5S)-2,5-dimethyl-1-phenylphospholane (dissolved in 10 ml of THF) are added dropwise at 0° C. to this suspension. The reaction solution is stirred at room temperature for 1 hour and subsequently transferred to a further reaction vessel, with the lithium remaining in the first vessel. 11.2 ml of chlorotrimethylsilane (dissolved in 10 ml of THF) are added to this reaction mixture. After 2 hours, the solvent is removed under reduced pressure and the crude product is distilled under reduced pressure (80-90° C./30 mbar).

Yield: 5.15 g; 68%

1H-NMR (CDCl3): δ=0.20 (d, 9H), 1.25-1.15 (m, 6H), 2.54-1.20 (m, 6H) ppm.

31P-NMR (CDCl3): δ=−54.4 ppm.

### Example 4

### 2,3-Bis[(R,R)-2,5-dimethylphospholanyl]maleic anhydride

4.71 g of (2R,5R)-2,5-dimethyl-1-trimethylsilylphospholane (dissolved in 5 ml of ether) are added at 0° C. to a solution of 2.09 g of dichloromaleic anhydride in 20 ml of ether and the mixture is stirred at this temperature for a further 15 minutes. After a further 30 minutes at room temperature, the solution is cooled to −78° C. The product crystallizes as brown crystals. The crystals are filtered off and dried under reduced pressure.

Yield: 3.56 g; 87%

1H-NMR (CDCl3): δ=1.06 (dd, 6H), 1.22 (dd, 6H), 2.49-1.25 (m, 12H), 3.32 (m, 2H) ppm.

31P-NMR (CDCl3): δ=−2.2 ppm.

### Example 5

### {2,3-Bis[(R,R)-2,5-dimethylphospholanyl]maleic anhydride}(cyclooctadiene)rhodium(I)tetrafluoroborate

1.90 g of 2,3-bis[(R,R)-2,5-dimethylphospholanyl]maleic anhydride are dissolved in 15 ml of THF and the solution is cooled to −20° C. 2.40 g of [Rh(COD)₂]BF₄ (suspended in 20 ml of THF) are slowly added to the solution. The solution is warmed to room temperature and stirred for a further 90 minutes. 25 ml of ether are added to the reaction solution and the product is subsequently filtered off. The crystals are washed with 25 ml of ether and dried under reduced pressure.

Yield: 3.51 g; 97%

1H-NMR (Aceton-d6): δ=1.23 (dd, 6H), 1.57 (dd, 6H), 2.67-1.50 (m 18H), 3.07 (m 2H), 5.15 (s, 2H), 5.85 (s, 2H) ppm.

31P-NMR (Aceton-d6): δ=63.8 (d, J=151 Hz) ppm.

### Example 6

### 2,3-Bis[(R,R)-2,5-dimethylphospholanyl]maleimide

A solution of 4.50 g of (2R,5R)-2,5-dimethyl-1-trimethylsilylphospholane (dissolved in 5 ml of THF) is added dropwise at 0° C. to a solution of 2.70 g of N-methyl-2,3-dibromomaleimide in 10 ml of THF and the mixture is stirred for a further one hour. The solvent and all volatile components are removed under reduced pressure. The product is isolated as a red-brown oil.

Yield: 3.20 g (94%)

1H-NMR (CDCl3): δ=1.05 (dd, 6H), 1.22 (dd, 6H), 1.78 (m, 2H), 2.05 (m, 2H), 2.26 (m, 2H), 2.42 (m, 2H), 2.98 (d, 3H), 3.32 (m, 2H) ppm.

31P-NMR (CDCl3):

δ=−4.9 ppm.

1-13. (canceled)

14. A process for preparing enantiomerically enriched compounds of the general formula (I), 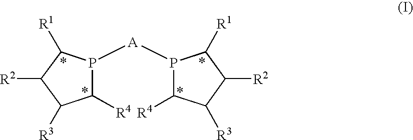
where
* indicates a stereogenic centre,
R¹ and R⁴ are each, independently of one another (C₁-C₈)-alkyl, HO—(C₁-C₈)-alkyl, (C₁-C₈)-alkoxy, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl,
R² and R³ are each, independently of one another, H, (C₁-C₈)-alkyl, HO—(C₁-C₈)-alkyl, (C₁-C₈)-alkoxy, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl,
A is a C₂ bridge in which two carbon atoms have sp² hybridization,
by reacting compounds of the general formula (II), 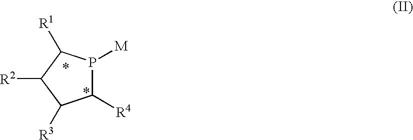
where
R¹ to R⁴ can be as defined above,
M is an alkali metal or a trimethylsilyl group,
with compounds of the general formula (III),
X-A-X (III)
where
A is as defined above and
the radicals X are each, independently of one another, a nucleofugic leaving group,
and wherein said compounds of the general formula (II) are prepared by reacting compounds of the general formula (IV), 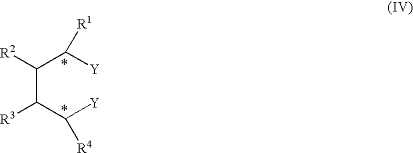
where
R¹ to R⁴ are as defined above and
the radicals Y are each, independently of one another, a nucleofugic leaving group,
with compounds of the general formula (V),
M₂P-Aryl (V)
where
M is an alkali metal and Aryl is a (C₆-C₁₈)-aryl or ((C₁-C₈)-alkyl)₁₋₃-(C₆-C₁₈)-aryl radical,
and subsequently with an alkali metal, and, if appropriate, additionally with trimethylsilyl chloride,
with the compounds of the formula (V) being obtained by reaction of compounds of the general formula (VI),
Hal₂P-Aryl (VI)
where
Aryl is as defined above,
with an alkali metal.

15. The process of claim 14, wherein A is a radical selected from the group consisting of: 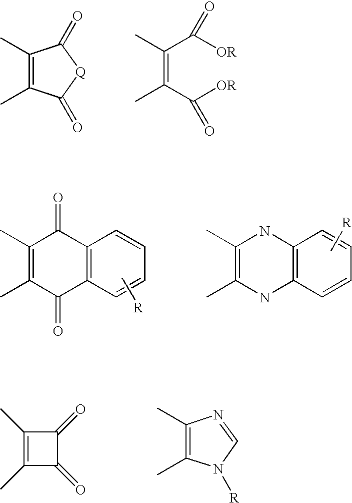
where
R is H, (C₁-C₈)-alkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl,
and Q is O, NH, NR.

16. The process of claim 15, wherein Q is oxygen or NR, where R can be (C₁-C₈)-alkyl, (C₆-C₁₈)-aryl, or benzyl.

17. The process of claim 16, wherein Q is oxygen or NR, where R can be methyl, ethyl, propyl, isopropyl, tert-butyl, phenyl, naphthyl, fluorenyl, or benzyl.

18. The process of claim 14, wherein for said compounds of formula IV, R² and R³ are each H and R¹ and R⁴ are each, independently of one another, (C₁-C₈)-alkyl, HO—(C₁-C₈)-alkyl, or (C₂-C₈)-alkoxyalkyl.

19. The process of claim 14, wherein for said compounds of formula (III) or (IV), X or Y is selected from the group consisting of halogen, OTos, OMes, triflate, and nosylate.

20. The process of claim 14, wherein said compounds of formula IV have a structure according to formula (VII) or (VIII), 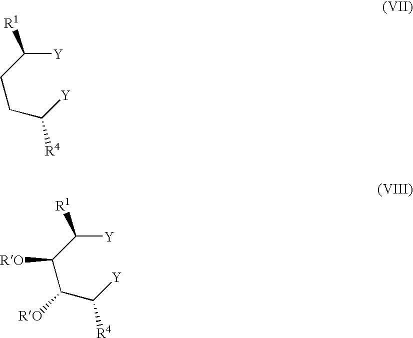
where
the radicals Y are independently selected from the group consisting of halogen, OTos, OMes, triflate, nosylate,
R¹ and R⁴ are each, independently of one another, (C₁-C₈)-alkyl, HO—(C₁-C₈)-alkyl, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl,
and the radicals R′ are each, independently of one another, H, (C₁-C₈)-alkyl, HO—(C₁-C₈)-alkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl.

21. The process of claim 20, wherein R′ is H, methyl, ethyl, propyl, isopropyl, tert-butyl, or phenyl, and
R¹ and R⁴ are each methyl, ethyl, propyl, isopropyl, tert-butyl, phenyl.

22. The process of the claim 14, wherein M is the alkali metal lithium.

23. The process of claim 14, wherein the reaction of said compounds of formula (VI) with alkali metals is carried out in an aprotic polar solvent.

24. The process of claim 14, wherein the reaction of said compounds of formula (IV) with said compounds of formula (V) is carried out at a temperature of from −25° C. to +40° C.

25. The process of claim 14, wherein said compounds of formula (VI) are reacted with an alkali metal at a temperature of −10° C. to +10° C.

26. The process of claim 14, wherein the reaction is carried out in a one-pot variant.

27. The process of claim 15, wherein for said compounds of formula IV, R² and R³ are each H and R¹ and R⁴ are each, independently of one another, (C₁-C₈)-alkyl, HO—(C₁-C₈)-alkyl, or (C₂-C₈)-alkoxyalkyl.

28. The process of claim 27, wherein for said compounds of formula (III) and (IV), X and Y are selected from the group consisting of halogen, OTos, OMes, triflate, and nosylate.

29. The process of claim 15, wherein said compounds of formula IV have a structure according to formula (VII) or (VIII), 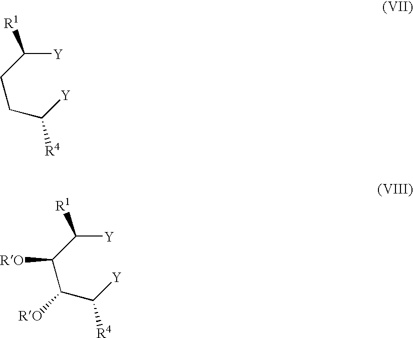
where
the radicals Y are independently selected from the group consisting of halogen, OTos, OMes, triflate, nosylate,
R¹ and R⁴ are each, independently of one another, (C₁-C₈)-alkyl, HO—(C₁-C₈)-alkyl, (C₂-C₈)-alkoxyalkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl,
and the radicals R′ are each, independently of one another, H, (C₁-C₈)-alkyl, HO—(C₁-C₈)-alkyl, (C₆-C₁₈)-aryl, (C₇-C₁₉)-aralkyl, (C₁-C₈)-alkyl-(C₆-C₁₈)-aryl, (C₃-C₈)-cycloalkyl, (C₁-C₈)-alkyl-(C₃-C₈)-cycloalkyl, (C₃-C₈)-cycloalkyl-(C₁-C₈)-alkyl.

30. The process of claim 29, wherein R′ is H, methyl, ethyl, propyl, isopropyl, tert-butyl, phenyl, and
R¹ and R⁴ are each methyl, ethyl, propyl, isopropyl, tert-butyl, phenyl.

31. The process of the claim 30, wherein M is the alkali metal lithium.

32. The process of claim 31, wherein the reaction of said compounds of formula (VI) with alkali metals is carried out in an aprotic polar solvent.

33. The process of claim 32, wherein the reaction of said compounds of formula (IV) with said compounds of formula (V) is carried out at a temperature of from −25° C. to +40° C.
